(19) United States
(12) Patent Application Publication
(10) Pub. No.: US 2022/0035281 A1
(43) Pub. Date: Feb. 3, 2022

(54) IMAGE FORMING APPARATUS

(71) Applicant: Konica Minolta, Inc., Tokyo (JP)

(72) Inventor: Toshihiro Wazumi, Tokyo (JP)

(21) Appl. No.: 17/378,555

(22) Filed: Jul. 16, 2021

(30) Foreign Application Priority Data
Jul. 28, 2020 (JP) 2020-127442

(51) Int. Cl. G03G 15/20

(52) U.S. Cl. CPC G03G 15/2028; G03G 15/2039

(57) ABSTRACT

An image forming apparatus includes: a contacting and separating part that is movable between a first position where a recording medium is contactable and a second position separated from the first position; and a hardware processor that controls a position of the contacting and separating part, based on temperature information of the recording medium.

The entire disclosure of Japanese patent Application No. 2020-127442, filed on Jul. 28, 2020, is incorporated herein by reference in its entirety.

### BACKGROUND

### Technological Field

The present invention relates to an image forming apparatus.

### Description of the Related Art

In image forming apparatuses of an electrophotographic system, there is known an image forming apparatus including a fixing part that fixes an image to a recording medium by heating and pressurizing the recording medium formed with the image. In the fixing part, a fixing temperature is controlled so as to be within a predetermined range from the viewpoint of a fixing property of the image.

For example, JP H9-68885 A discloses a configuration that performs control to correct a temperature of a fixing part (heating roller) in accordance with a detection temperature of a recording medium, in consideration that the heat of the fixing part is deprived by the recording medium at the time of fixing of an image onto the recording medium.

In addition, toner that is an image to be formed on the recording medium contains a release agent (wax) from the viewpoint of releasability in the fixing part. This release agent is present as a liquid at a high temperature, and solidifies by a temperature drop. Therefore, an image is to be a lamination of a release layer including the release agent and a toner layer, and the release layer is located on a surface of the image after fixing.

Meanwhile, in a process of temperature transition, there are a case where the release agent becomes transparent and a case where the release agent becomes cloudy, depending on a temperature change amount when the temperature transitions in a predetermined temperature range. Specifically, the release layer becomes transparent when the temperature change amount during transition within the predetermined temperature range is relatively large, and the release layer becomes cloudy when the temperature change amount during transition within the predetermined temperature range is relatively small.

Since the image forming apparatus is provided with a member (a roller, a guide, a rolling element, a bearing, and the like) in contact with a recording medium in a conveyance path of the recording medium, the recording medium may be deprived of heat by such a member. That is, the presence of this member causes a nonuniform temperature state in a width direction of the recording medium. Therefore, a state of the release layer (surface layer) in the image may have possibly become nonuniform in the width direction, which may have accordingly caused an occurrence of gloss unevenness in the image.

### SUMMARY

An object of the present invention is to provide an image forming apparatus capable of suppressing a nonuniform state of a surface layer in an image in a width direction.

To achieve the abovementioned object, according to an aspect of the present invention, an image forming apparatus reflecting one aspect of the present invention comprises: a contacting and separating part that is movable between a first position where a recording medium is contactable and a second position separated from the first position; and a hardware processor that controls a position of the contacting and separating part, based on temperature information of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically showing an overall configuration of an image forming apparatus according to an embodiment of the present invention;

FIG. 2 is a diagram showing a main part of a control system of the image forming apparatus according to an embodiment of the present embodiment;

FIG. 3A is a side view of a fixing part and a conveyance roller unit;

FIG. 3B is a view of the fixing part and the conveyance roller unit as viewed from above;

FIG. 4 is a view showing a temperature change of a sheet at a position in a sheet conveyance direction;

FIG. 5 is a view showing a temperature change of a sheet at a position in a width direction;

FIG. 6A is a side view of the conveyance roller unit located at a second position;

FIG. 6B is a view showing a temperature change of a sheet at a position in a sheet conveyance direction when the conveyance roller unit is located at the second position;

FIG. 7 is a view showing an example of a table in which a position of a conveyance roller unit is associated with a color including a plurality of layers and a sheet size or an image area;

FIG. 8 is a flowchart showing an operation example of position determination control of the conveyance roller unit in the image forming apparatus;

FIG. 9 is a side view of a fixing part and a conveyance roller unit in a form having a plurality of conveyance roller units;

FIG. 10 is a view showing a temperature change of a sheet at a position in a sheet conveyance direction in the form according to FIG. 9;

FIG. 11 is a side view of a fixing part and a conveyance roller unit in a form including a temperature detection part; and

FIG. 12 is a view showing a temperature change of a sheet at a position in a sheet conveyance direction in the form according to FIG. 11.

### DETAILED DESCRIPTION OF EMBODIMENTS

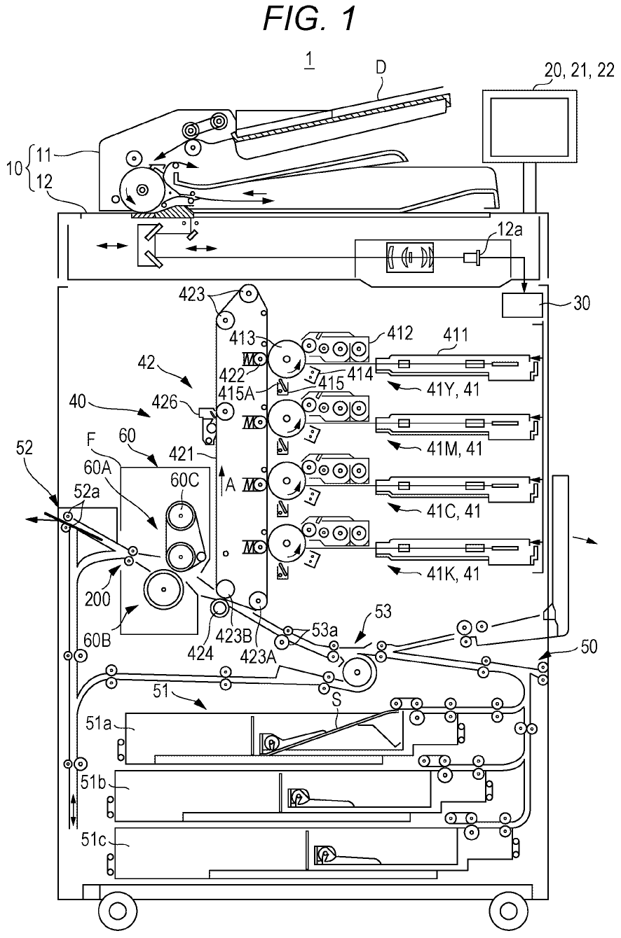

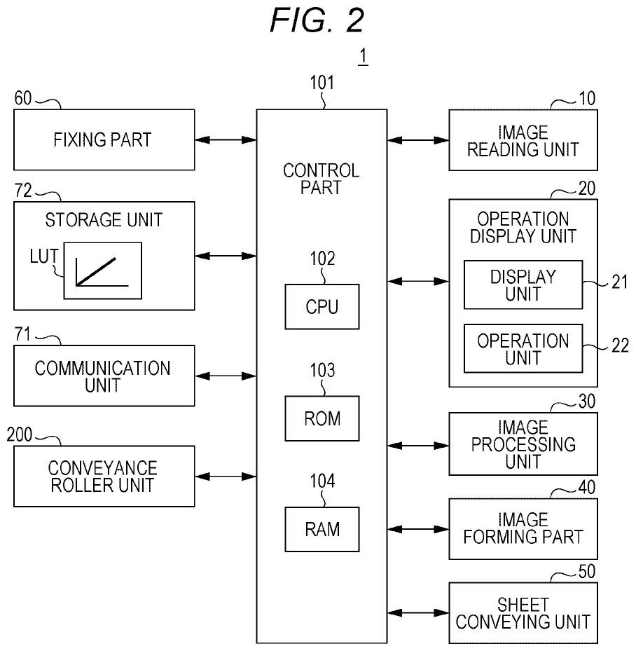

Hereinafter, one or more embodiments of the present invention will be described with reference to the drawings. However, the scope of the invention is not limited to the disclosed embodiments. FIG. 1 is a view schematically showing an overall configuration of an image forming apparatus 1 according to an embodiment of the present invention. FIG. 2 is a diagram showing a main part of a control system of the image forming apparatus 1 according to an embodiment of the present embodiment.

The image forming apparatus 1 shown in FIGS. 1 and 2 is an intermediate-transfer color image forming apparatus using an electrophotographic process technology. That is, the image forming apparatus 1 primarily transfers respective color toner images of yellow (Y), magenta (M), cyan (C), and black (K) formed on a photosensitive drum 413 to an intermediate transfer belt 421, superimposes the four color toner images on the intermediate transfer belt 421, and then secondary transfers the toner images onto a sheet S (recording medium), to form an image.

Further, to the image forming apparatus 1, a tandem method is employed in which the photosensitive drums 413 corresponding to the four colors of YMCK are arranged in series in a traveling direction of the intermediate transfer belt 421, and toner images of the respective colors are sequentially transferred to the intermediate transfer belt 421 in a single procedure.

As shown in FIG. 2, the image forming apparatus 1 includes an image reading unit 10, an operation display unit 20, an image processing unit 30, an image forming part 40, a sheet conveying unit 50, a fixing part 60, and a control part 101.

The control part 101 includes a central processing unit (CPU) 102, a read only memory (ROM) 103, a random access memory (RAM) 104, and the like. The CPU 102 reads a program according to processing contents from the ROM 103, develops the program in the RAM 104, and cooperates with the developed program to control an operation of each block of the image forming apparatus 1. At this time, various data stored in a storage unit 72 are referred to. The storage unit 72 is formed by, for example, a non-volatile semiconductor memory (so-called flash memory) or a hard disk drive.

The control part 101 exchanges various data with an external device (for example, a personal computer) connected to a communication network such as a local area network (LAN) or a wide area network (WAN) via a communication unit 71. For example, the control part 101 receives image data transmitted from the external device, and forms an image on the sheet S on the basis of the image data (input image data). The communication unit 71 is formed by, for example, a communication control card such as a LAN card.

As shown in FIG. 1, the image reading unit 10 includes an automatic document feeding device 11 called an auto document feeder (ADF), a document image scanning device 12 (scanner), and the like.

The automatic document feeding device 11 conveys a document D placed on a document tray by a conveyance system, and sends the document D to the document image scanning device 12. The automatic document feeding device 11 enables continuous reading of images (including both sides) at once of a large number of the documents D placed on the document tray.

The document image scanning device 12 optically scans a document conveyed onto a contact glass from the automatic document feeding device 11 or a document placed on the contact glass, and forms an image of reflected light from the document onto a light receiving surface of a charge coupled device (CCD) sensor 12a, to read the document image. The image reading unit 10 generates input image data on the basis of a reading result of the document image scanning device 12. The image processing unit 30 applies predetermined image processing to the input image data.

As shown in FIG. 2, the operation display unit 20 is formed by, for example, a liquid crystal display (LCD) with a touch panel, and functions as a display unit 21 and an operation unit 22. The display unit 21 displays various operation screens, a state of an image, an operation status of each function, and the like in accordance with a display control signal inputted from the control part 101. The operation unit 22 includes various operation keys such as a ten key and a start key, receives various input operations by a user, and outputs an operation signal to the control part 101.

The image processing unit 30 includes a circuit or the like that performs digital image processing according to initial setting or user setting, on the input image data. For example, the image processing unit 30 performs gradation correction on the basis of gradation correction data (gradation correction table) under the control of the control part 101. Further, the image processing unit 30 performs, on the input image data, various correction processes such as color correction and shading correction in addition to the gradation correction, compression processing, and the like. On the basis of the image data subjected to these processes, the image forming part 40 is controlled.

As shown in FIG. 1, the image forming part 40 includes: image forming units 41Y, 41M, 41C, and 41K that form an image with respective color toners of a Y component, an M component, a C component, and a K component on the basis of input image data; an intermediate transfer unit 42; and the like.

The image forming units 41Y, 41M, 41C, and 41K for the Y component, the M component, the C component, and the K component have a similar configuration. For convenience of illustration and description, common constituents are denoted by the same reference numerals, and the individual constituents are indicated by adding Y, M, C or K to the reference numerals when being distinguished. In FIG. 1, reference numerals are given exclusively to the constituents of the image forming unit 41Y for the Y component, and reference numerals of the constituents of other image forming units 41M, 41C, and 41K are omitted.

The image forming unit 41 includes an exposure device 411, a developing device 412, the photosensitive drum 413, a charging device 414, a drum cleaning device 415, and the like.

The photosensitive drum 413 is made of, for example, an organic photoreceptor in which a photosensitive layer made of a resin containing an organic photoconductor is formed on an outer peripheral surface of a drum-shaped metal base.

The control part 101 controls a drive current supplied to a drive motor (not shown) that rotates the photosensitive drum 413, to rotate the photosensitive drum 413 at a constant peripheral speed.

The charging device 414 is, for example, an electrostatic charger, and generates corona discharge to uniformly charge a surface of the photoconductive photosensitive drum 413 to a negative polarity.

The exposure device 411 is formed by, for example, a semiconductor laser, and irradiates the photosensitive drum 413 with a laser beam corresponding to an image of each color component. As a result, an electrostatic latent image of each color component is formed on an image region irradiated with the laser light on the surface of the photosensitive drum 413, due to a potential difference with a background region.

The developing device 412 is a two-component reverse rotation developing device, and visualizes the electrostatic latent image to form a toner image by causing developer of each color component to adhere to the surface of the photosensitive drum 413.

The developing device 412 is applied with, for example, a DC developing bias having the same polarity as a charging polarity of the charging device 414, or a developing bias in which a DC voltage having the same polarity as a charging polarity of the charging device 414 is superimposed on an AC voltage. As a result, reverse development is performed in which toner is made adhere to the electrostatic latent image formed by the exposure device 411.

The drum cleaning device 415 is in contact with a surface of the photosensitive drum 413, has a flat drum cleaning blade 415A made of an elastic body, and the like, and removes toner remaining on the surface of the photosensitive drum 413 without being transferred to the intermediate transfer belt 421.

The intermediate transfer unit 42 includes the intermediate transfer belt 421, a primary transfer roller 422, a plurality of support rollers 423, a secondary transfer roller 424, a belt cleaning device 426, and the like. The intermediate transfer belt 421 corresponds to an “image carrier” of the present invention.

The intermediate transfer unit 42 is formed by an endless belt, and is stretched around the plurality of support rollers 423 in a loop. At least one of the plurality of support rollers 423 is formed by a drive roller, and others are formed by a driven roller. For example, it is desirable that a roller 423A disposed downstream of the primary transfer roller 422 for the K component in a belt traveling direction is the drive roller. This makes it easy to keep a constant traveling speed of the belt in a primary transfer nip. As the drive roller 423A rotates, the intermediate transfer belt 421 travels at a constant speed in an arrow A direction.

The primary transfer roller 422 is disposed on an inner peripheral surface side of the intermediate transfer belt 421, so as to face the photosensitive drum 413 of each color component. By pressure contact of the primary transfer roller 422 and the photosensitive drum 413 with the intermediate transfer belt 421 interposed in between, the primary transfer nip for transfer of a toner image from the photosensitive drum 413 to the intermediate transfer belt 421 is formed.

The secondary transfer roller 424 is disposed on an outer peripheral surface side of the intermediate transfer belt 421, so as to face a backup roller 423B disposed on downstream of the drive roller 423A in the belt traveling direction. By pressure contact of the secondary transfer roller 424 and the backup roller 423B with the intermediate transfer belt 421 interposed in between, a secondary transfer nip for transfer of a toner image from the intermediate transfer belt 421 to the sheet S is formed.

When the intermediate transfer belt 421 passes through the primary transfer nip, the toner image on the photosensitive drum 413 is sequentially superimposed and primarily transferred on the intermediate transfer belt 421. Specifically, by applying a primary transfer bias to the primary transfer roller 422, and supplying a charge of a polarity opposite to that of the toner to a back surface side of the intermediate transfer belt 421, that is, a side in contact with the primary transfer roller 422, the toner image is electrostatically transferred to the intermediate transfer belt 421.

Thereafter, when the sheet S passes through the secondary transfer nip, the toner image on the intermediate transfer belt 421 is secondarily transferred to the sheet S. Specifically, by applying a secondary transfer bias to the backup roller 423B, and supplying a charge of the same polarity as that of the toner to a front surface side of the sheet S, that is, a side in contact with the intermediate transfer belt 421, the toner image is electrostatically transferred to the sheet S, and the sheet S is conveyed toward the fixing part 60.

The belt cleaning device 426 removes transfer residual toner remaining on a surface of the intermediate transfer belt 421 after the secondary transfer. Note that, instead of the secondary transfer roller 424, a so-called belt secondary transfer unit may be employed in which the secondary transfer belt is stretched in a loop around a plurality of support rollers including a secondary transfer roller.

The fixing part 60 is disposed downstream of a conveyance roller unit 200 described later, in the conveyance direction of the sheet S. The fixing part 60 includes: an upper fixing part 60A having a fixing-surface-side member disposed on a fixing surface side of the sheet S, that is, on a surface side formed with the toner image; a lower fixing part 60B having a back-surface-side support member disposed on a back surface side of the sheet S, that is, on a side opposite to the fixing surface side; a heating source 60C; and the like. By pressure contact of the back-surface-side support member and the fixing-surface-side member, a fixing nip to hold and convey the sheet S is formed.

The fixing part 60 fixes the toner image onto the sheet S by heating and pressurizing, with the fixing nip, the sheet S on which the toner image has been secondarily transferred and that has been conveyed. The fixing part 60 is disposed as a unit in a fixing device F.

The sheet conveying unit 50 includes a sheet feeding unit 51, a sheet discharging unit 52, a conveyance path part 53, and the like. In three sheet feeding tray units 51a to 51c forming the sheet feeding unit 51, the sheets S identified on the basis of a basis weight, a size, and the like are accommodated for each preset type. The conveyance path part 53 has a plurality of conveying rollers such as a registration roller pair 53a.

The sheets S accommodated in the sheet feeding tray units 51a to 51c are fed one by one from the top and conveyed to the image forming part 40 by the conveyance path part 53. Then, the toner image of the intermediate transfer belt 421 is secondarily transferred collectively on one side of the sheet S in the image forming part 40, and a fixing process is performed in the fixing part 60. The sheet S formed with the image is discharged outside the apparatus by the sheet discharging unit 52 provided with a sheet discharge roller 52a.

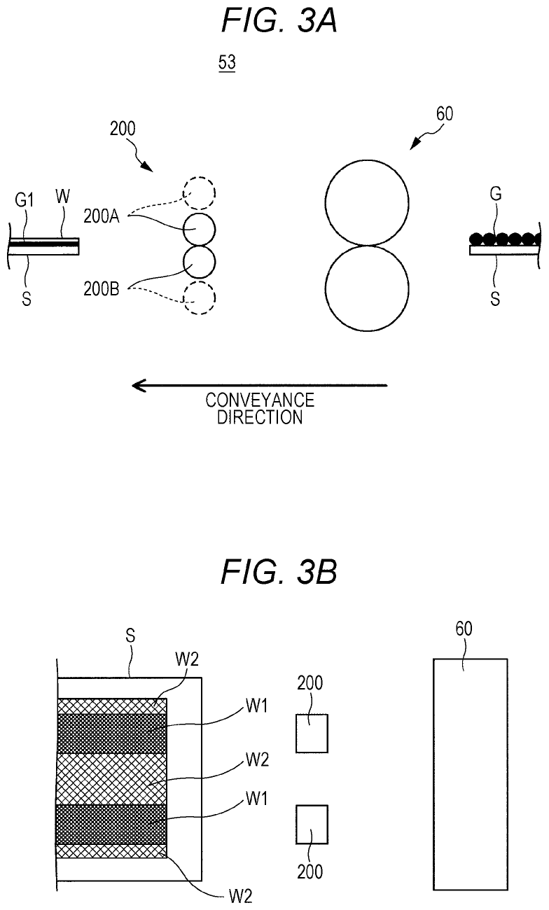

As shown in FIGS. 3A and 3B, the plurality of conveyance rollers in the conveyance path part 53 include the conveyance roller unit 200 disposed between the fixing part 60 and the sheet discharging unit 52. The conveyance roller unit 200 is made of metal, for example, and two conveyance rollers are arranged side by side in the width direction of the sheet S. An interval between the two conveyance roller units 200 is set in accordance with a width of the sheet having the minimum size applicable to the image forming apparatus 1.

The conveyance roller unit 200 is able to contact or separate from the sheet S conveyed through the conveyance path part 53. Specifically, the conveyance roller unit 200 is a roller pair including an upper roller 200A and a lower roller 200B, and is movable between a first position (a position indicated by a solid line) where the sheet S is contactable and a second position (a position indicated by a broken line) separated from the first position. The conveyance roller unit 200 corresponds to a “contacting and separating part” of the present invention.

The first position is a position where the upper roller 200A and the lower roller 200B are in contact with each other. When the conveyance roller unit 200 is located at the first position, the sheet S passes through a contact portion (nip portion) between the upper roller 200A and the lower roller 200B.

The second position is a position where the upper roller 200A and the lower roller 200B are separated from each other. When the conveyance roller unit 200 is located at the second position, the upper roller 200A is located at a position separated above the conveyed sheet S, and the lower roller 200B is located at a position separated below the conveyed sheet S.

Note that a moving mechanism in the conveyance roller unit 200 may be any mechanism as long as the mechanism enables the upper roller 200A and the lower roller 200B to move, such as a known mechanism.

The control part 101 controls the position of the conveyance roller unit 200 on the basis of temperature information of the sheet S such that a state of a release layer (surface layer) of an image to be formed on the sheet S becomes uniform. Specifically, the control part 101 estimates a temperature change of the sheet S caused by the conveyance roller unit 200 located at the first position, on the basis of the temperature information. Then, the control part 101 controls the position of the conveyance roller unit 200 on the basis of an estimation result of the temperature change.

The temperature information of the sheet S is, for example, information (a basis weight, a size, a texture direction, and the like) regarding a type of the sheet S inputted to the image forming apparatus 1. This is because, for example, since the fixing temperature in the fixing part 60 is determined, the temperature of the sheet S can be experimentally estimated on the basis of the fixing temperature.

Furthermore, the temperature information of the sheet S may be, for example, information on at least one of a temperature or a humidity around the image forming apparatus 1. This is because the temperature of the sheet S can be experimentally estimated from a relationship between the fixing temperature and the information on at least one of the temperature or the humidity around the image forming apparatus 1. Note that the information on the temperature and the humidity around the image forming apparatus 1 is information of a temperature-and-humidity detection unit provided in the image forming apparatus 1, a temperature-and-humidity detection unit provided around the image forming apparatus 1, and the like, and the image forming apparatus 1 acquires the information automatically or by manual input by a user.

The temperature change of the sheet S caused by the conveyance roller unit 200 located at the first position is a temperature change of the sheet S between before the sheet S passes through the conveyance roller unit 200 and after the sheet S passes through the conveyance roller unit 200, when the conveyance roller unit 200 is located at the first position.

Since the sheet S is deprived of heat by the conveyance roller unit 200 by the contact between the sheet S and the conveyance roller unit 200 when the sheet S passes through the portion of the conveyance roller unit 200, the temperature of the sheet S becomes lower than that before the contact with the conveyance roller unit 200.

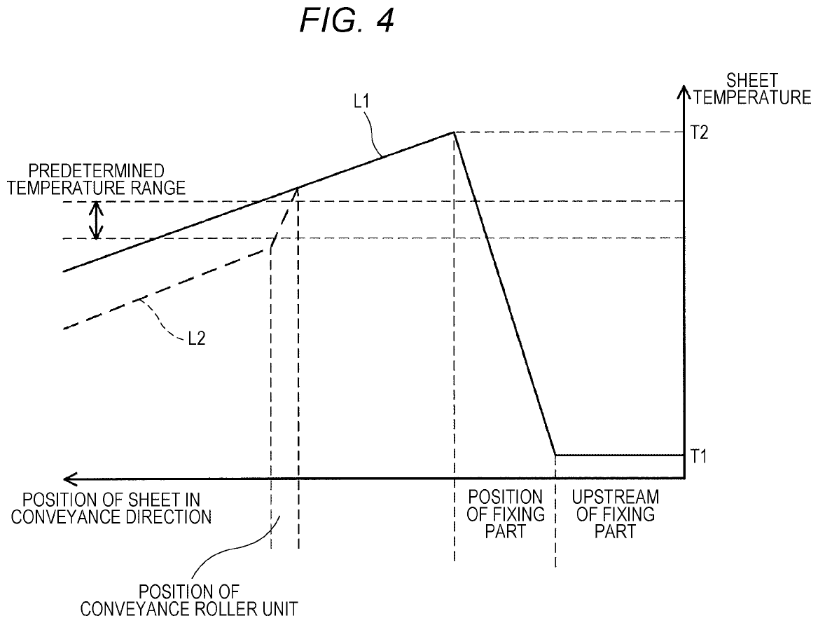

For example, it has been experimentally found that the temperature of the sheet S when passing through the vicinity of the fixing part 60 changes as indicated by a solid line L1 shown in FIG. 4. More specifically, the temperature of the sheet S is T1 at a position upstream of the fixing part 60, but the sheet S is heated by the fixing part 60 when the sheet S passes through the position of the fixing part 60, which rapidly increases the temperature of the sheet S from T1 to T2. Then, as the sheet S goes downstream of the fixing part 60, the temperature of the sheet S gradually decreases due to heat dissipation. A horizontal axis (a position of sheet S) in FIG. 4 indicates a position from upstream to downstream in the conveyance direction, from the right to the left.

However, when a contact member that comes into contact with the sheet S being conveyed, such as the conveyance roller unit 200, is present in the conveyance path part 53, the temperature of the sheet S rapidly decreases at a position of a contact portion with the contact member as indicated by a broken line L2 shown in FIG. 4. That is, a temperature change amount per unit time of the sheet S increases before and after the position of the contact portion.

Here, for example, as in the present embodiment, in a case of the conveyance roller unit 200 configured by a pair of rollers in which two contact members are arranged in the width direction, the temperature over the width direction of the sheet S is not to be uniform after the contact with the conveyance roller unit 200.

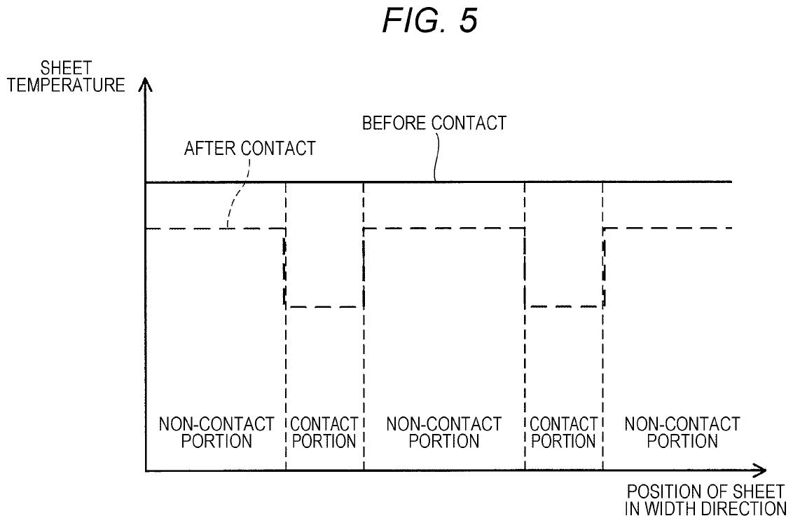

Specifically, in the width direction, the sheet S has a portion (contact portion) that comes into contact with the conveyance roller unit and a portion (non-contact portion) that does not come into contact with the conveyance roller unit 200. For example, as shown in FIG. 5, a temperature distribution in the width direction of the sheet S is such that the contact portion is recessed with respect to the non-contact portion.

Therefore, a phenomenon occurs in which a temperature change of the sheet S in a portion corresponding to the contact portion becomes larger than a temperature change of a portion corresponding to the non-contact portion, before and after the contact of the conveyance roller unit 200.

As shown in FIG. 3A, toner G that is an image to be formed on the sheet S contains a release agent (for example, wax) for delamination of the fixing part 60 and the image. This release agent is present as a liquid at a high temperature, and solidifies by a temperature drop. Therefore, the image is to be a lamination of a release layer W made of the release agent and a toner layer G1 made of the toner G, and the release layer W is located on a surface of the image after fixing.

In the process of temperature transition around the fixing part 60, there are a case where the release agent becomes transparent and a case where the release agent becomes cloudy, depending on a temperature change amount when the temperature transitions in a predetermined temperature range. The predetermined temperature range is, for example, a range of 50 to 90° C., and is a crystallization temperature when the release agent is crystalline, and a temperature range from a melting point to a glass transition point when the release agent is non-crystalline.

The release agent (release layer) becomes transparent when the temperature change amount during transition within the predetermined temperature range is relatively large, while the release agent (release layer) becomes cloudy when the temperature change amount during transition within the predetermined temperature range is relatively small.

As described above, when the sheet S having passed through the fixing part 60 passes through the portion of the conveyance roller unit 200, the temperature change amount at the contact portion with the conveyance roller unit 200 is larger than that at the non-contact portion. Therefore, when the temperature of the sheet S at the time of passing through the vicinity of the conveyance roller unit 200 is close to the predetermined temperature range, in the image, the transparent portion and the cloudy portion of the release layer may appear in the image.

For example, as shown in FIG. 3B, when the temperature change amount from a temperature immediately before the contact to a temperature immediately after the contact at the contact portion of the sheet S with the conveyance roller unit 200 is large enough to straddle the predetermined temperature range, the release layer at the contact portion becomes transparent (a portion W1 in FIG. 3B).

Whereas, in the non-contact portion of the sheet S with the conveyance roller unit 200, since a temperature change amount from the temperature immediately before the contact to the temperature immediately after the contact remains gentle, the release layer at the non-contact portion becomes cloudy (a portion W2 in FIG. 3B).

Therefore, in the image formed on the sheet S, a state of the release layer W is different between the portion in contact with the conveyance roller unit 200 and the portion in contact with the conveyance roller unit 200. That is, the state of the release layer W on the sheet S becomes nonuniform in the width direction, which accordingly causes an occurrence of gloss unevenness (streak) in the image.

In the present embodiment, the control part 101 estimates a temperature change in the contact portion described above, on the basis of temperature information of the sheet S. The estimated temperature change is a temperature change amount or the like that is experimentally calculated in consideration of, for example, a type of the sheet S (a basis weight, a size, a texture direction, and the like), image forming conditions (a conveyance speed of the sheet S, a fixing temperature, image data, and the like), a material of the conveyance roller unit 200, and the like.

The control part 101 determines the position of the conveyance roller unit 200 in accordance with a relationship between the range of the temperature that transitions within a predetermined time, which is based on the estimation result, and the predetermined temperature range. More specifically, when the range of the temperature that transitions within the predetermined time straddles the predetermined temperature range, the control part 101 determines the position of the conveyance roller unit 200 at the second position.

The predetermined time is a time from when a leading end of the sheet S reaches the conveyance roller unit 200 to when a terminal end of the sheet S passes through the conveyance roller unit 200, for example, when the conveyance roller unit 200 is located at the first position, and is a time that can be set on the basis of a conveyance speed or the like.

When the range of the temperature that transitions within the predetermined time (for example, a time corresponding to a range corresponding to the position of the conveyance roller unit in FIG. 4) straddles the predetermined temperature range, the release layer becomes transparent. This is different from the cloudy state of the release layer in the non-contact portion, and thus the possibility of an occurrence of gloss unevenness is increased.

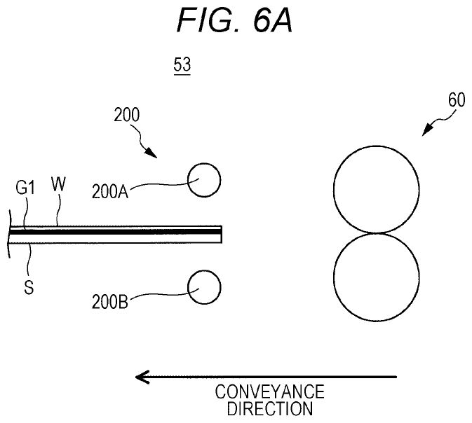

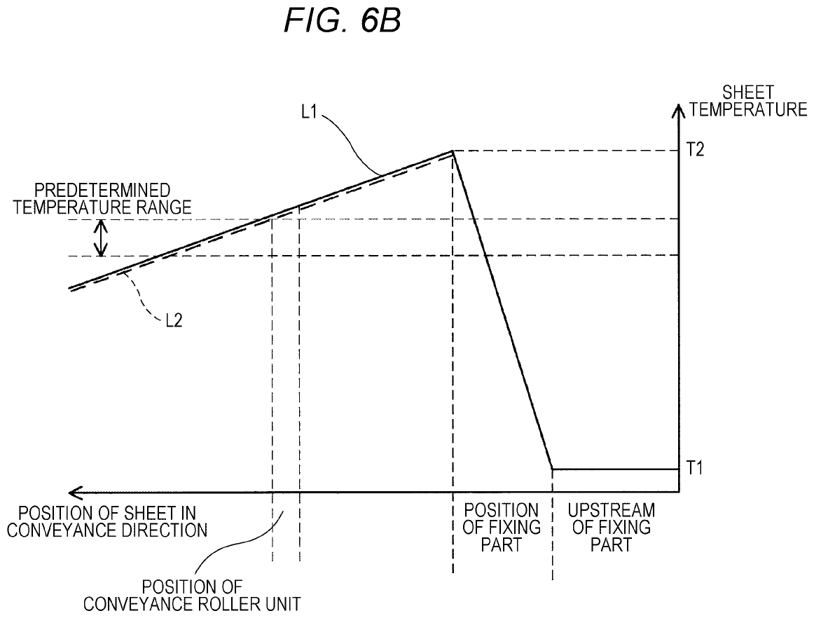

Therefore, in this case, by separating the conveyance roller unit 200 from the conveyed sheet S as the second position as shown in FIG. 6A, the temperature change caused by the contact with the conveyance roller unit 200 no longer occurs. As a result, as shown in FIG. 6B, a portion indicated by the broken line L2 has an equal temperature to that of a portion indicated by the solid line L1, which makes it possible to suppress a nonuniform state of the release layer in the image in the width direction. This can accordingly suppress an occurrence of gloss unevenness in the image.

When the range of the temperature that transitions within the predetermined time does not straddle the predetermined temperature range, the control part 101 determines the position of the conveyance roller unit 200 at the first position.

In this case, since the release layer at the contact portion is less likely to become transparent, the sheet S can be reliably conveyed by setting the conveyance roller unit 200 at the first position.

Even in a case where the range of the temperature that transitions within the predetermined time does not straddle the predetermined temperature range, for example, when the range of the temperature that transitions within the predetermined time approaches most of the predetermined temperature range, the control part 101 may determine the position of the conveyance roller unit 200 at the second position. A degree of the approach of this range of the temperature to the predetermined temperature range can be freely determined.

Further, the control part 101 may determine the position of the conveyance roller unit 200 on the basis of information on image data to be formed on the sheet S, in addition to the information regarding the temperature of the sheet S.

For example, in a case of a single-layer solid image including a solid image of one color such as the Y color alone, the M color alone, the C color alone, and the K color alone, even if gloss unevenness occurs, it is difficult for the user to visually recognize the gloss unevenness.

Therefore, when the image data relates to a one-layer solid image, the control part 101 determines the position of the conveyance roller unit 200 at the first position.

In addition, in a case of a multi-layer solid image including a solid image using two or more colors (for example, Red, Blue, Green) among the Y color, the M color, the C color, and the K color, when gloss unevenness occurs, it is easy for the user to visually recognize the gloss unevenness.

Therefore, when the image data relates to a multi-layer solid image, the control part 101 determines the position of the conveyance roller unit 200 at the second position.

This makes it easy to suppress an occurrence of gloss unevenness.

In addition, even in the case of the multi-layer solid image, it may be difficult for the user to visually recognize even if gloss unevenness occur, depending on an image area. For example, for an image formed on a sheet having a small sheet size such as a postcard size, or an image having an image area of 40 cm² or less, the gloss unevenness is less conspicuous even if gloss unevenness occurs, since the image size is small.

Further, in a case of a sheet having a small sheet size (for example, a postcard-sized sheet), it becomes difficult to convey the sheet S when the conveyance roller unit 200 is located at the second position. Therefore, as long as the gloss unevenness is in a range of being not conspicuous, it is considered that the priority of the conveyability may be increased in consideration of the reliability of the conveyance and the conveyance efficiency.

Therefore, when the image data is the multi-layer solid image, the control part 101 may determine the position of the conveyance roller unit 200 in accordance with the image size. The image size may be determined on the basis of a sheet size or may be determined on the basis of an image area.

For example, when the sheet size is a postcard size, or when the image area is 40 cm² or less, the control part 101 determines the position of the conveyance roller unit 200 at the first position. When the sheet size is A4S size or more, or when the image area is 60 cm² or more, the control part 101 determines the position of the conveyance roller unit 200 at the second position.

In this way, the conveyance roller unit 200 can be set to the first position to ensure the conveyability by the conveyance roller unit 200 when gloss unevenness is not conspicuous even in the multi-layer solid image, and the conveyance roller unit 200 can be set at the second position to suppress an occurrence of gloss unevenness when gloss unevenness is conspicuous.

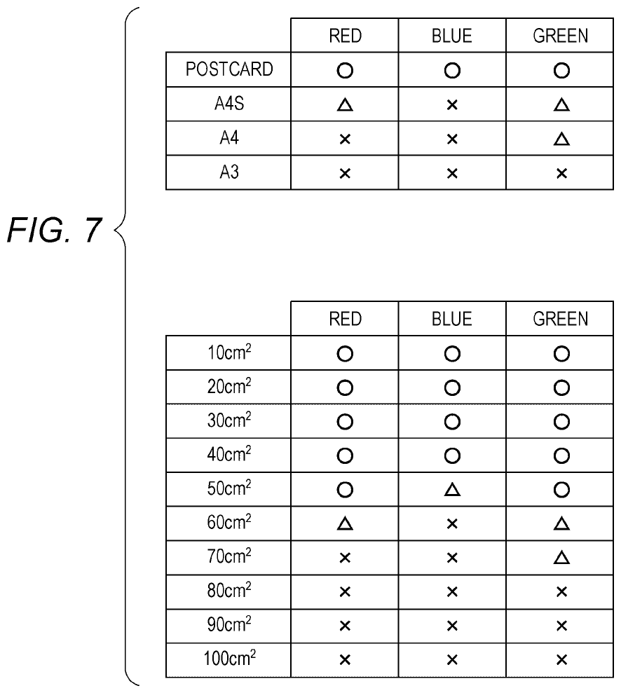

Further, as shown in FIG. 7, the first position or the second position may be determined by referring to a table in which a position of the conveyance roller unit 200 is associated with a color, a sheet size, or an image area.

A table on an upper side in FIG. 7 is a table in which a position of the conveyance roller unit 200 is associated with a color and a sheet size. A table on a lower side in FIG. 7 is a table in which a position of the conveyance roller unit 200 is associated with a color and an image area. In FIG. 7, “a” indicates that gloss unevenness is less conspicuous, “A” indicates that gloss unevenness is slightly conspicuous, and “x” indicates that gloss unevenness is conspicuous. These tables are stored in, for example, the storage unit 72 or the like.

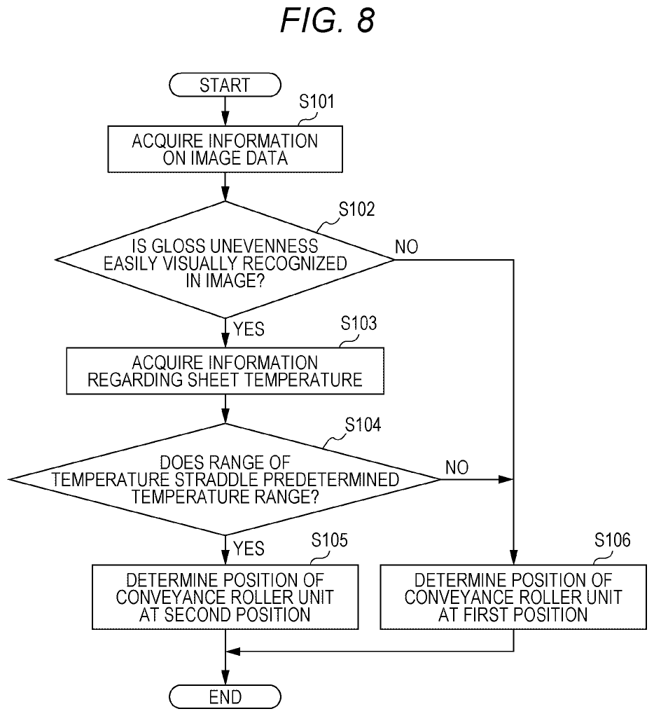

An operation example of position determination control of the conveyance roller unit 200 in the image forming apparatus 1 configured as described above will be described. FIG. 8 is a flowchart showing an operation example of the position determination control of the conveyance roller unit 200 in the image forming apparatus 1. A process in FIG. 8 is appropriately executed, for example, when the image forming apparatus 1 receives a print job execution command.

As shown in FIG. 8, the control part 101 acquires information on image data (step S101). Next, control part 101 determines whether or not an image related to the image data is an image in which gloss unevenness is easily visually recognized (step S102).

As a result of the determination, in a case of an image in which gloss unevenness is not easily visually recognized (step S102, NO), the process proceeds to step S106. Whereas, in a case of an image in which gloss unevenness is easily visually recognized (YES in step S102), the control part 101 acquires information regarding a temperature of the sheet S (step S103), and determines whether or not the range of the temperature that transitions within the predetermined time straddles a predetermined temperature range (step S104).

As a result of the determination, when the range of the temperature straddles the predetermined temperature range (YES in step S104), the control part 101 determines the position of the conveyance roller unit 200 at the second position (step S105). Whereas, when the range of the temperature does not straddle the predetermined temperature range (step S104, NO), the control part 101 determines the position of the conveyance roller unit 200 at the first position (step S106). After step S105 or step S106, this control ends.

In the above flowchart, steps S101 and S102 and steps S103 and S104 are combined. However, the present invention is not limited to this, and the flowchart of one of steps S101 and S102 and steps S103 and S104 may be exclusively used.

According to an embodiment of the present embodiment configured as described above, it is possible to suppress a nonuniform temperature state of the sheet S in the width direction, by controlling the position of the conveyance roller unit 200. As a result, it is possible to suppress a nonuniform state of the release layer (surface layer) in the image in the width direction, and accordingly to suppress an occurrence of gloss unevenness in the image.

Further, a temperature change of the sheet S caused by the conveyance roller unit 200 in a case of being located at the first position is estimated on the basis of temperature information of the sheet S, and the position of the conveyance roller unit 200 is controlled on the basis of the estimation result. As a result, it is possible to easily separate a case of prioritizing conveyability by the conveyance roller unit 200 from a case of prioritizing uniformity of a state of the release layer.

In addition, since the conveyance roller unit 200 is made of metal, heat of the sheet S is easily deprived, which accordingly easily lowers the temperature of the sheet S, and easily causes a nonuniform temperature state of the sheet S in the width direction.

In the present embodiment, the position of the conveyance roller unit 200 can be controlled to the second position. Therefore, even in a configuration in which the temperature state of the sheet S in the width direction is likely to be nonuniform, nonuniformity of the temperature state of the sheet S in the width direction can be suppressed, and accordingly the state of the release layer in the image of the sheet S can be made uniform.

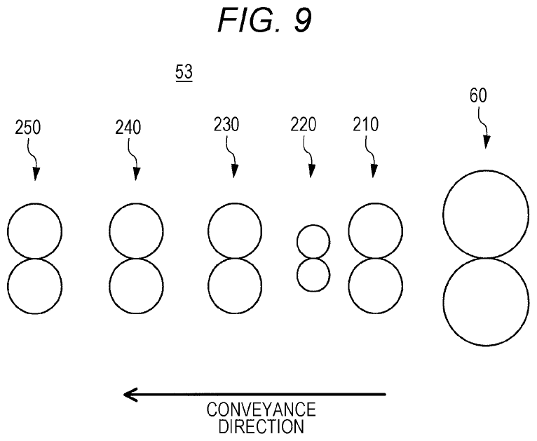

In the above embodiment, the configuration has one conveyance roller unit 200 alone. However, the present invention is not limited to this, and for example, as shown in FIG. 9, the configuration may be provided with a plurality of conveyance rollers.

In this configuration, on a downstream side of the fixing part 60 in the conveyance path part 53, a first conveyance roller unit 210, a second conveyance roller unit 220, a third conveyance roller unit 230, a fourth conveyance roller unit 240, and a fifth conveyance roller unit 250 are provided in this order in the conveyance direction.

Each of the first conveyance roller unit 210, the second conveyance roller unit 220, the third conveyance roller unit 230, the fourth conveyance roller unit 240, and the fifth conveyance roller unit 250 is a roller pair including an upper roller and a lower roller.

Each of the first conveyance roller unit 210, the second conveyance roller unit 220, the third conveyance roller unit 230, the fourth conveyance roller unit 240, and the fifth conveyance roller unit 250 is movable between the first position where the sheet S is contactable and the second position separated from the first position. Movement of the upper roller and the lower roller is similar to that of the conveyance roller unit 200 described above.

Similarly to the conveyance roller unit 200, the second conveyance roller unit 220 has a configuration in which two rollers are arranged in the width direction. Each of the first conveyance roller unit 210, the third conveyance roller unit 230, the fourth conveyance roller unit 240, and the fifth conveyance roller unit 250 is a roller longer than a width of the sheet S in the width direction.

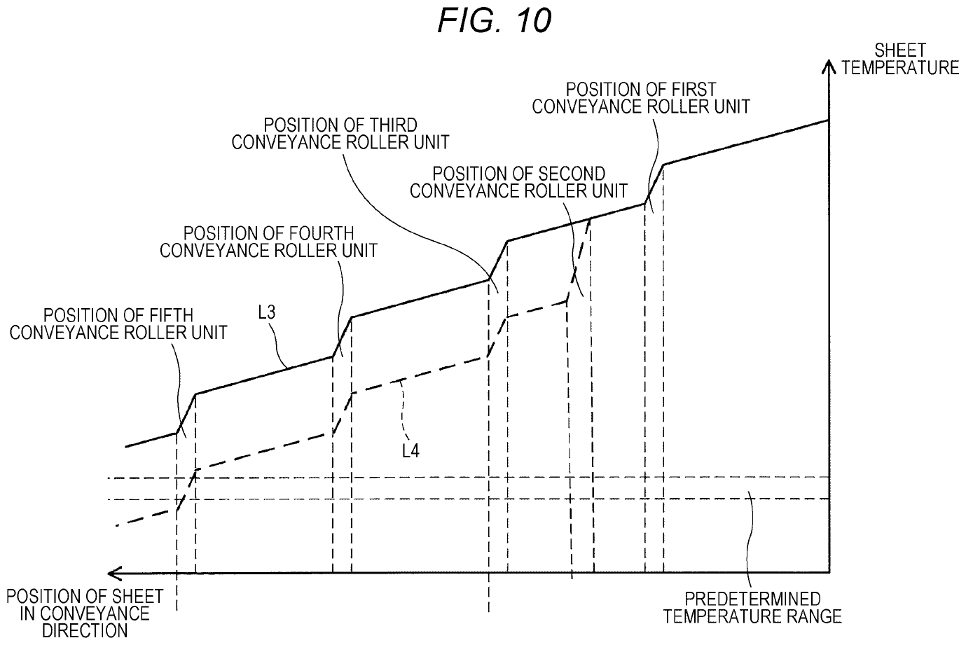

In this configuration, as shown in FIG. 10, since the temperature of the sheet S rapidly decreases at the contact portion with each roller unit, a temperature distribution of the sheet S becomes a distribution in which the temperature decreases stepwise toward the downstream side in the conveyance direction (see a solid line L3 and a broken line L4).

Specifically, the sheet S has the contact portion and the non-contact portion with the second conveyance roller unit 220 in a portion of the second conveyance roller unit 220. Therefore, as indicated by the broken line L4, the temperature distribution corresponding to the contact portion is to be a distribution in which the temperature becomes lower at the portion of the second conveyance roller unit 220 than that of the temperature distribution (solid line L3) corresponding to the non-contact portion.

Note that, in portions of the first conveyance roller unit 210, the third conveyance roller unit 230, the fourth conveyance roller unit 240, and the fifth conveyance roller unit 250, the entire sheet S in the width direction is contacted. Therefore, the temperature related to the contact portion and the non-contact portion evenly decreases in the portion of each roller unit.

This causes a difference in a temperature distribution between the contact portion and the non-contact portion of the second conveyance roller unit 220. Therefore, for example, when the temperature of a portion corresponding to the contact portion overlaps with a predetermined temperature range at the portion in contact with any roller unit, gloss unevenness may occur.

Therefore, in such a case, for example, the control part 101 sets the second conveyance roller unit 220 to the second position. This allows the temperature distribution of the broken line L4 to be matched with the solid line L3, and thus the state of the release layer in the image can be made uniform in the width direction, which can accordingly suppress an occurrence of gloss unevenness.

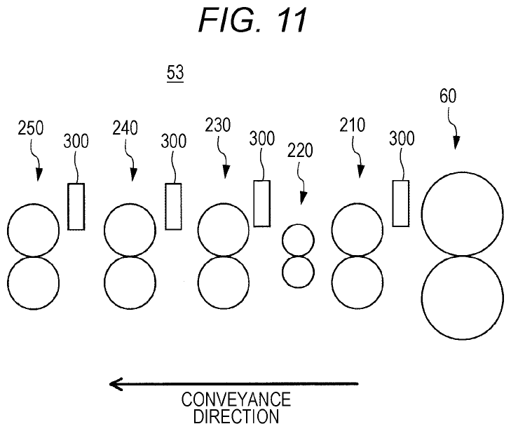

Furthermore, in the above embodiment, as shown in FIG. 11, a temperature detection part 300 may be provided. The configuration shown in FIG. 11 is provided with a plurality of conveyance roller units similarly to the configuration shown in FIG. 9. Moreover, a temperature detection part may be provided in the configuration shown in FIG. 3A or the like.

The temperature detection part 300 is provided in the conveyance path part of the sheet S, and detects a temperature of the sheet S. One temperature detection part 300 is provided in front of each of the first conveyance roller unit 210, the third conveyance roller unit 230, the fourth conveyance roller unit 240, and the fifth conveyance roller unit 250.

The control part 101 controls a position of each conveyance roller unit on the basis of information related to a detection result of the temperature detection part 300.

For example, in a portion where the temperature rapidly changes, in a case where a portion reaching the predetermined temperature range is a portion corresponding to the fifth conveyance roller unit 250, the control part 101 sets the fifth conveyance roller unit 250 to the second position and sets the other roller units to the first position.

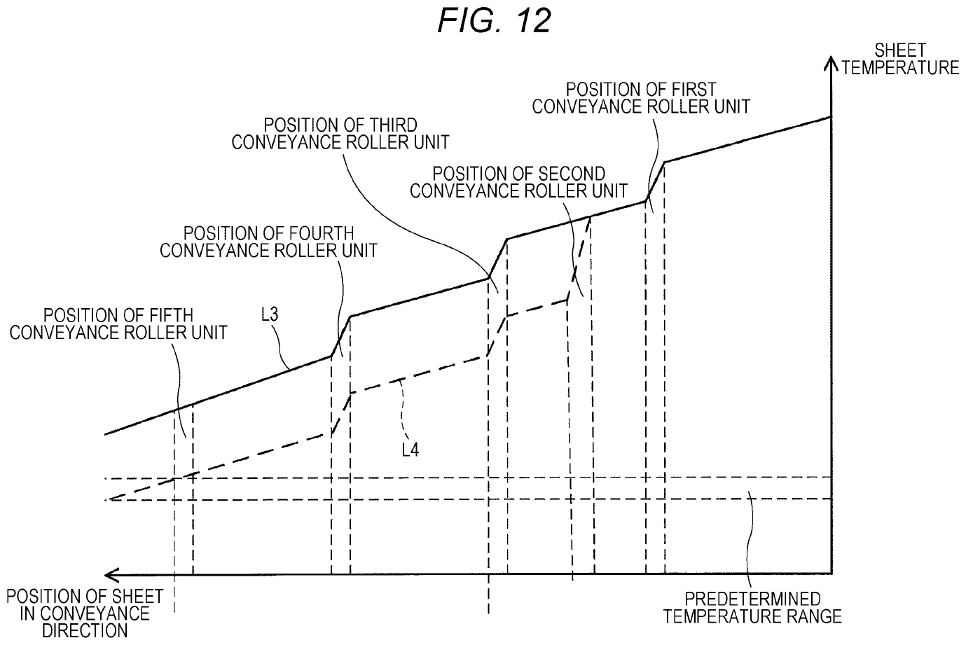

As a result, as shown in FIG. 12, a temperature change amount per unit time in the fifth conveyance roller unit 250 can be delayed, which makes it possible to suppress the predetermined temperature range being straddled by the range of the temperature that transitions within the predetermined time. As a result, a state of the release layer can be made uniform even when there is a difference in temperature distribution by having the contact portion and the non-contact portion with the second conveyance roller unit 220, and accordingly an occurrence of gloss unevenness can be suppressed.

In addition, since the sheet temperature can be directly measured, the position determination control in the conveyance roller unit can be accurately performed.

Further, in the above embodiment, the position of the conveyance roller unit 200 is controlled on the basis of information regarding a sheet temperature and information on image data. However, the present invention is not limited to this, and the position of the conveyance roller unit 200 may be controlled on the basis of read information of an image formed on the sheet S.

In this way, the position of the conveyance roller unit 200 can be controlled after checking of the presence or absence of gloss unevenness in the image formed on the sheet S, so that reliable position determination control can be performed.

Furthermore, the control part 101 may control the position of the conveyance roller unit 200 on the basis of information regarding conveyance of the sheet.

For example, when the conveyance roller unit is located at the second position, there is a possibility that the sheet can no longer be conveyed depending on a sheet size. Therefore, from the viewpoint of ensuring the conveyability, in a case where the sheet size is too small to convey the sheet (for example, a postcard size), the control part 101 determines the conveyance roller unit 200 at the first position.

Further, in a case of the configuration including the plurality of conveyance roller units, for example, the control part 101 exclusively determines the conveyance roller unit capable of securing the conveyability at the first position, and determines others at the second position. This makes it possible to control movement of the conveyance roller unit while ensuring the conveyance of the sheet.

In addition, in a state where the conveyance roller unit is not able to be set to the second position from the viewpoint of ensuring the conveyability or the like, the control part 101 may control a fixing temperature in the fixing part 60. This can inhibit a nonuniform state of the release layer in the image, for example, even when the sheet comes into contact with the conveyance roller unit and the sheet temperature decreases, by increasing the fixing temperature to such an extent that the range of the temperature that transitions within the predetermined time does not reach the predetermined temperature range.

Further, by changing a timing at which the conveyance roller unit is shifted from the first position to the second position, a decrease range of the sheet temperature may be reduced.

For example, the control part controls the conveyance roller unit to move to the second position in the middle of conveyance, after the sheet is conveyed to some extent by the conveyance roller unit.

This makes it possible to reduce a temperature change amount that changes due to the contact with the conveyance roller unit, so that the range of the temperature that transitions within the predetermined time does not straddle the predetermined temperature range. As a result, a nonuniform state of the release layer in the image can be inhibited.

In the above embodiment, the conveyance roller unit is exemplified as the contacting and separating part, but the present invention is not limited to this. For example, the contacting and separating part may be any member as long as the member can contact the sheet, such as a guide member, a rolling element, or a bearing.

In the above embodiment, the contacting and separating part (conveyance roller unit) is made of metal, but the present invention is not limited to this, and the contacting and separating part may be made of a material other than metal.

In the above embodiment, the toner contains the release agent, but the present invention is not limited to this, and the toner may contain other substances that can be a surface layer of an image.

In addition, the position of the contacting and separating part may be controlled on the basis of temperature information of the sheet other than those exemplified above. Furthermore, each piece of the temperature information of the sheet exemplified above may be appropriately combined.

Although embodiments of the present invention have been described and illustrated in detail, the disclosed embodiments are made for purposes of illustration and example only and not limitation. That is, the present invention can be implemented in various forms without departing from the scope or main features of the present invention. The scope of the present invention should be interpreted by terms of the appended claims

What is claimed is:

1. An image forming apparatus comprising:
a contacting and separating part that is movable between a first position where a recording medium is contactable and a second position separated from the first position; and
a hardware processor that controls a position of the contacting and separating part, based on temperature information of the recording medium.

2. The image forming apparatus according to claim 1, wherein
the hardware processor controls a position of the contacting and separating part in such a way that a state of a surface layer of an image to be formed on the recording medium becomes uniform.

3. The image forming apparatus according to claim 1, wherein
the hardware processor
estimates, based on the temperature information, a temperature change of the recording medium caused by the contacting and separating part when the recording medium is located at the first position, and
determines a position of the contacting and separating part based on an estimation result of the temperature change.

4. The image forming apparatus according to claim 3, wherein
the hardware processor determines a position of the contacting and separating part based on a relationship between a range of a temperature that transitions within a predetermined time, the range being based on the estimation result, and a predetermined temperature range.

5. The image forming apparatus according to claim 4, wherein
the hardware processor determines a position of the contacting and separating part at the second position when the range of the temperature straddles the predetermined temperature range.

6. The image forming apparatus according to claim 3, further comprising:
a temperature detection part that detects a temperature of the recording medium, wherein
the hardware processor controls a position of the contacting and separating part based on information related to a detection result of the temperature detection part.

7. The image forming apparatus according to claim 3, wherein
the hardware processor controls a position of the contacting and separating part based on information of the recording medium inputted to the image forming apparatus.

8. The image forming apparatus according to claim 3, wherein
the hardware processor controls a position of the contacting and separating part, based on information on at least one of a temperature or a humidity around the image forming apparatus.

9. The image forming apparatus according to claim 1, wherein
the hardware processor controls a position of the contacting and separating part based on information on image data to be formed on the recording medium.

10. The image forming apparatus according to claim 1, wherein
the hardware processor controls a position of the contacting and separating part based on read information of an image formed on the recording medium.

11. The image forming apparatus according to claim 1, wherein
the contacting and separating part is provided in a conveyance path part on which the recording medium is conveyed.

12. The image forming apparatus according to claim 11, further comprising:
a fixing part that is disposed on an upstream side from the contacting and separating part in a conveyance direction of the recording medium, and heats and fixes an image onto the recording medium.

13. The image forming apparatus according to claim 12, wherein
an image to be formed on the recording medium contains a release agent that serves as a surface layer of the image and that is for delamination of the fixing part from the image.
